(19) United States
(12) Patent Application Publication
(10) Pub. No.: US 2007/0242023 A1
(43) Pub. Date: Oct. 18, 2007

(54) DRIVING APPARATUS

(76) Inventor: Chih-Jen Yen, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/308,982

(22) Filed: Jun. 2, 2006

(30) Foreign Application Priority Data
Apr. 14, 2006 (TW) 95113327

(51) Int. Cl. G09G 3/36

(52) U.S. Cl. 345/100

(57) ABSTRACT

A driving apparatus for driving a display panel having N data lines is provided. The driving apparatus comprises a driving unit and a switching unit. The driving unit includes N/K output ends, wherein N and K is a positive integer. The driving unit receives data signals and latches the data signals. And, the driving unit converts the data signals into N/K driving signals, and then outputs those driving signals respectively from N/K output ends. The switching unit includes N/K input ends and N output ends. The switching unit selects N/K output ends from the N output ends for outputting data and makes each input end be coupled to one of the corresponding output ends selected. Each of the input ends of the switching unit is respectively coupled to the corresponding output end of the driving unit.

### CROSS-REFERENCE TO RELATED APPLICATION

This application claims the priority benefit of Taiwan application serial no. 95113327, filed on Apr. 14, 2006. All disclosure of the Taiwan application is incorporated herein by reference.

### BACKGROUND OF THE INVENTION

1. Field of Invention

The present invention relates to a driving apparatus. More particularly, the present invention relates to a driving apparatus capable of reducing the circuit area and cost.

2. Description of Related Art

Column drivers are used to generate a plurality of analog driving signals according to a digital data signal output by a timing controller, so as to control and drive a display panel. FIG. 1 is the block diagram of the conventional column driver device. Referring to FIG. 1, a shift register 101, a first line latch 102, a second line latch 103, a level shifter 104, and a signal converter 105 are included. The shift register 101 includes N output ends; and the first line latch 102, the second line latch 103, the level shifter 104, and the signal converter 105 include N input ends and N output ends.

The shift register 101 is used to receive a clock signal CLK and a first control signal CT1, generate N latch signals according to the clock signal CLK and the first control signal CT1, and then output the N latch signals respectively from the N output ends of the shift register 101. Each of the input ends of the first line latch 102 is respectively coupled to a corresponding output end of the shift register 101. The first line latch 102 receives N latch signals, latches the input data signals according to the N latch signals, and outputs the latched data signals from the N output ends of the first line latch 102.

Each of the input ends of the second line latch 103 is respectively coupled to a corresponding output end of the first line latch 102. The second line latch 103 receives and latches data signals output by the first line latch 102 according to a second control signal CT2, and then outputs the latched data signals respectively from the N output ends of the second line latch 103. Each of the input ends of the level shifter 104 is respectively coupled to a corresponding output end of the second line latch 103, the level shifter 104 receives and shifts the voltage levels of the data signals output by the second line latch 103, and outputs the data signals with voltage level shifted respectively from the N output ends of the level shifter 104.

Each of the input ends of the signal converter 105 is respectively coupled to a corresponding output end of the level shifter 104, the signal converter receives the data signals output by the level shifter 104, converts the data signals into N driving signals, and outputs the N driving signals respectively from the N output ends of the signal converter 105. In FIG. 1, OUT1˜OUT(N) indicate the driving signals.

The circuit area of the column driver is directly proportional to the number of input ends and output ends of the digital circuit portion of the column driver, and the cost of the circuit also increases several-fold as the number of the input ends and output ends increase. Therefore, how to reduce the circuit area and cost and achieve the original function of the column driver is an urgent problem for those in this field to solve.

### SUMMARY OF THE INVENTION

An objective of the present invention is to provide a driving apparatus capable of reducing the circuit area and cost.

Based on the above and other objectives, the present invention provides a driving apparatus suitable for driving a display panel having N data lines, wherein N is a positive integer. The driving apparatus comprises a driving unit and a switching unit. The driving unit comprises N/K output ends, wherein K is a positive integer. The driving unit receives data signals and latches the data signals, converts the data signals into N/K driving signals, and then outputs the N/K driving signals respectively from N/K output ends. The switching unit comprises N/K input ends and N output ends. The switching unit receives a switch-control signal, selects N/K output ends from N output ends for outputting data according to the switch-control signal, and switches each of the input ends respectively to one of the selected output ends, wherein each of the input ends of the switching unit is respectively coupled to a corresponding output end of the driving unit.

Based on the above and other objectives, the present invention provides a driving apparatus suitable for driving a display panel having N data lines, wherein N is a positive integer. The driving apparatus comprises a data latch unit, a switching unit, and a signal converting unit. The data latch unit comprises N/K output ends, wherein K is a positive integer. The data latch unit receives and latches the data signals, and outputs the latch results respectively from N/K output ends of the data latch unit after latching the data signals. The switching unit comprises N/K input ends and N output ends. The switching unit receives a switch-control signal, selects N/K output ends from the N output ends according to the switch-control signal, and switches each of the input ends respectively to one of the selected output ends, wherein each of the input ends of the switching unit is respectively coupled to a corresponding output end of the data latch unit. The signal converting unit comprises N input ends and N output ends. Each of the input ends of the signal converting unit is respectively coupled to a corresponding output end of the switching unit, the signal converting unit receives the data signals output by the switching unit, converts the data signals into N driving signals, and then outputs the N driving signals to N data lines of the display panel.

According to the driving apparatus described in an embodiment of the present invention, the above driving unit comprises a data latch unit and a signal converting unit. The data latch unit comprises N/K output ends. The data latch unit receives and latches the data signals, and outputs the latch results respectively from the N/K output ends of the data latch unit after latching the data signals. The signal converting unit comprises N/K input ends and N/K output ends. Each of the input ends of the signal converting unit is respectively coupled to a corresponding output end of the data latch unit, the signal converting unit receives the data signals output by the data latch unit, and converts the data signals into N/K driving signals.

According to the driving apparatus described in an embodiment of the present invention, the above data latch unit comprises a shift register, a first line latch, a second line latch, and a level shifter. The shift register is used to receive a clock signal and a first control signal, generate latch signals according to the clock signal and the first control signal, and then output the latch signals respectively from the output ends of the shift register. The first line latch comprises input ends and N/K output ends. The input ends of the first line latch are coupled to the output ends of the shift register for receiving the latch signals, latching the data signals according to the timing of the latch signals, and then outputting the latched data signals respectively from the N/K output ends of the first line latch.

The second line latch comprises N/K input ends and N/K output ends. Each of the input ends of the second line latch is respectively coupled to a corresponding output end of the first line latch, the second line latch receives the data signals output by the first line latch, latches the data signals output by the first line latch according to a second control signal, and outputs the latched data signals respectively from the N/K output ends of the second line latch. The level shifter comprises N/K input ends and N/K output ends. Each of the input ends of the level shifter is respectively coupled to a corresponding output end of the second line latch, the level shifter receives the data signals output by the second line latch and changes the voltage level thereof, and then outputs the data signals with voltage level changed respectively from the N/K output ends of the level shifter.

According to the driving apparatus described in an embodiment of the present invention, the above data latch unit comprises a shift register, a first line latch and a second line latch. The shift register is used to receive a clock signal and a first control signal, generate latch signals according to the clock signal and the first control signal, and then output the latch signals respectively from the output ends of the shift register. The first line latch comprises input ends and N/K output ends. The input ends of the first line latch are coupled to the output ends of the shift register for receiving the latch signals, latching the data signals according to the timing of the latch signals, and then outputting the latched data signals respectively from the N/K output ends of the first line latch. The second line latch comprises N/K input ends and N/K output ends. Each of the input ends of the second line latch is respectively coupled to a corresponding output end of the first line latch, the second line latch receives the data signals output by the first line latch, latches the data signals output by the first line latch according to a second control signal, and outputs the latched data signals respectively from the N/K output ends of the second line latch.

According to the driving apparatus described in an embodiment of the present invention, the above signal converting unit comprises a decoder and a reference voltage generating unit. The decoder comprises N/K input ends and N/K output ends. Each of the input ends of the decoder is respectively coupled to a corresponding output end of the level shifter, and the input ends of the decoder receive N/K data signals output by the level shifter, convert the data signals into the corresponding N/K driving signals, and output the N/K driving signals respectively from the N/K output ends of the decoder. The reference voltage generating unit is coupled to the decoder for outputting a plurality of reference voltage signals to the decoder, such that the decoder converts the data signals received by the signal converting unit into the corresponding N/K driving signals according to the reference voltage signals.

According to the driving apparatus described in an embodiment of the present invention, the above signal converting unit comprises a decoder and a reference voltage generating unit. The decoder comprises N input ends and N output ends. Each of the input ends of the decoder is respectively coupled to a corresponding output end of the switching unit, the decoder receives the data signals output by the switching unit, converts the data signals into N driving signals, and outputs the N driving signals respectively from the N output ends of the decoder. The reference voltage generating unit is coupled to the decoder for outputting a plurality of reference voltage signals to the decoder, such that the decoder converts the data signals received by the signal converting unit into the corresponding N driving signals according to the reference voltage signals.

According to the driving apparatus described in an embodiment of the present invention, the above signal converting unit comprises a level shifter, a decoder, and a reference voltage generating unit. The level shifter comprises N input ends and N output ends. Each of the input ends of the level shifter is respectively coupled to a corresponding output end of the switching unit, the level shifter receives and changes the voltage levels of the data signals output by the switching unit, and outputs the data signals with the voltage level changed respectively from the N output ends of the level shifter. The decoder comprises N input ends and N output ends. Each of the input ends of the decoder is respectively coupled to a corresponding output end of the level shifter, the decoder receives the data signals output by the level shifter, converts the data signals into N driving signals, and outputs the N driving signals respectively from the corresponding N output ends of the decoder. The reference voltage generating unit is coupled to the decoder for outputting a plurality of reference voltage signals to the decoder, such that the decoder converts the data signals received by the signal converting unit into N driving signals according to the reference voltage signals.

According to the driving apparatus described in an embodiment of the present invention, the above reference voltage generating unit comprises a reference voltage generator and a voltage buffer. The reference voltage generator is used for generating the reference voltage signals. The voltage buffer is coupled to the reference voltage generator and the decoder for receiving and enhancing the driving capability of the reference voltage signals, and outputting the reference voltage signals with the driving capability enhanced to the decoder.

The number of the input ends and output ends of the digital circuit part of the present invention is reduced to be N/K than that of the conventional column driver (the number of the input ends and output ends thereof is supposed to be N), and the switching unit having N/K input ends and N output ends is adopted to perform K switches, so as to respectively output the N/K driving signals which are output by the digital circuit portion K times, thus achieving the original function of column driver and meanwhile reducing the area and cost of the digital circuit portion. Of course, it is obvious to the users that the above switching unit can also be disposed in the digital circuit portion. However, the number of the input ends and output ends of each device of the digital circuit portion must be adjusted correspondingly.

In order to make the aforementioned and other objects, features and advantages of the present invention comprehensible, preferred embodiments accompanied with figures are described in detail below.

### BRIEF DESCRIPTION OF THE DRAWINGS

FIG. 1 is a block diagram of the conventional column driver device.

FIG. 2 shows a driving apparatus according to an embodiment of the present invention.

FIG. 3 is a signal timing diagram of the conventional column driver as shown in FIG. 1.

FIG. 4 is a signal timing diagram of the driving apparatus of FIG. 2 according to an embodiment of the present invention.

FIG. 5 and FIG. 6 are the driving apparatuses according to other embodiments of the present invention.

### DESCRIPTION OF EMBODIMENTS

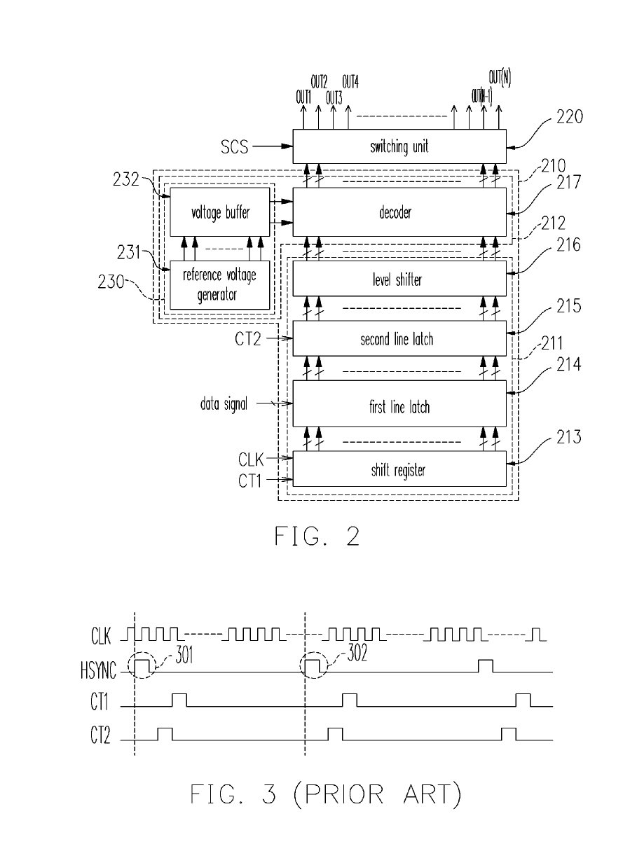

FIG. 2 is a driving apparatus according to an embodiment of the present invention. The driving apparatus is suitable for driving a display panel having N data lines, wherein N is a positive integer, and the driving apparatus comprises a driving unit 210 and a switching unit 220. The driving unit 210 includes N/K output ends, wherein K is a positive integer, and the driving unit 210 receives and latches an input data signals, converts the data signals into N/K driving signals, and then outputs the N/K driving signals respectively from the N/K output ends. The switching unit 220 includes N/K input ends and N output ends, wherein each of the input ends of the switching unit 220 is respectively coupled to a corresponding output end of the driving unit 210. The switching unit 220 receives a switch-control signal SCS, switches each of the input ends respectively to one of the corresponding output ends selected according to the switch-control signal SCS, and selects N/K output ends from the N output ends for outputting data. In this embodiment, the switching unit 220 can be implemented with a demultiplexer (DEMUX). In FIG. 2, OUT1˜OUT(N) indicate the driving signals.

The above driving unit 210 includes a data latch unit 211 and a signal converting unit 212. The data latch unit 211 includes N/K output ends, and the data latch unit 211 is used for receiving and latching the input data signals, and outputting the latch results respectively from the N/K output ends of the data latch unit 211 after latching the data signals. The signal converting unit 212 includes N/K input ends and N/K output ends, and each of the input ends of the signal converting unit 212 is respectively coupled to a corresponding output end of the data latch unit 211. The signal converting unit 212 receives the data signals output by the data latch unit 211, and converting the data signals into N/K driving signals.

The data latch unit 211 includes a shift register 213, a first line latch 214, a second line latch 215, and a level shifter 216. The shift register 213 includes N/K output ends, and the shift register 213 is used to receive a clock signal CLK and a first control signal CT1, generate N/K latch signals according to the clock signal CLK and the first control signal CT1, and then output the N/K latch signals respectively from the N/K output ends of the shift register 213. The first line latch 214 includes N/K input ends and N/K output ends, and each of the input ends of the first line latch 214 is respectively coupled to a corresponding output end of the shift register 213. The first line latch 214 receives N/K latch signals, latches the input data signals according to the timing of the N/K latch signals, and outputting the latched data signals respectively from the N/K output ends of the first line latch 214.

The second line latch 215 includes N/K input ends and N/K output ends, and each of the input ends of the second line latch 215 is respectively coupled to a corresponding output end of the first line latch 214. The second line latch 215 receives the data signals output by the first line latch 214, latches the data signals output by the first line latch 214 according to a second control signal CT2, and then outputs the latched data signals respectively from the N/K output ends of the second line latch 215.

The level shifter 216 includes N/K input ends and N/K output ends, and each of the input ends of the level shifter 216 is respectively coupled to a corresponding output end of the second line latch 215. The level shifter 216 receives the data signals output by the second line latch 215 and changes the voltage levels of the data signals, and outputs the data signals with voltage level changed respectively from the N/K output ends of the level shifter 216.

The signal converting unit 212 includes a decoder 217 and a reference voltage generating unit 230. The decoder 217 includes N/K input ends and N/K output ends, and each of the input ends of the decoder 217 is respectively coupled to a corresponding output end of the level shifter 216, and the input ends of the decoder 217 receive the N/K data signals output by the level shifter 216, convert the data signals into N/K driving signals, and then output the N/K driving signals respectively from the N/K output ends of the decoder 217.

The reference voltage generating unit 230 is coupled to the decoder 217 for outputting a plurality of reference voltage signals to the decoder 217, such that the decoder 217 can convert the data signals received by the signal converting unit 212 into corresponding N/K driving signals according to the reference voltage signals. The reference voltage generating unit 230 includes a reference voltage generator 231 and a voltage buffer 232. The reference voltage generator 231 is used to generate the reference voltage signals. The voltage buffer 232 is coupled to the reference voltage generator 231 and the decoder 217 for receiving and enhancing the driving capability of the reference voltage signals output by the reference voltage generator 231, and outputting the reference voltage signals with the driving capability enhanced to the decoder 217.

It is obvious to those of ordinary skill in the art that the signal converting unit 212 can be implemented in another manner. For example, the reference voltage generator 231 is directly connected to the decoder 217, and the voltage buffer 232 is disposed between the decoder 217 and the switching unit 220 instead. Or, a digital-to-analog converter having at least N/K channels is used to implement the signal converting unit 212. If those of ordinary skill in the art use the digital-to-analog converter to implement the signal converting unit 212, each of the channels of the digital-to-analog converter is respectively coupled to a corresponding output end of the data latch unit 211. The digital-to-analog converter receives the data signals output by the data latch unit 211, converts the data signals into N/K driving signals, and then outputs the N/K driving signals to the switching unit 220.

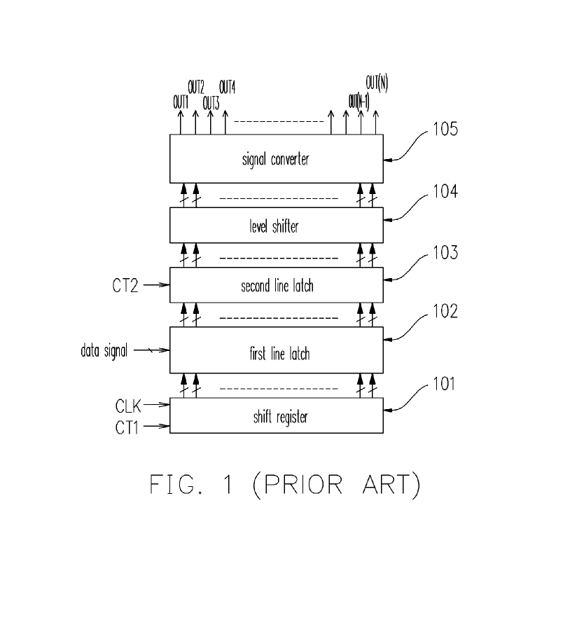

In addition, the above switch-control signal SCS can be provided internally or externally by the driving apparatus. The above shift register 213, the first line latch 214, the second line latch 215, the level shifter 216, and the decoder 217 constitute the digital circuit portion of the driving apparatus. In this embodiment, the digital circuit portion can be implemented by any technical means. The driving apparatus of the embodiment employs the switching unit 220 to perform K switches, and only a driving unit 210 having N/K channels is thus used to achieve the function of driving N data lines of the display panel. Thus, in order to use the driving apparatus of the present invention, the frequencies of the first control signal CT1 and the second control signal CT2 must be changed to be K times than that of the first control signal CT1 and the second control signal CT2 of the conventional column driver of FIG. 1.

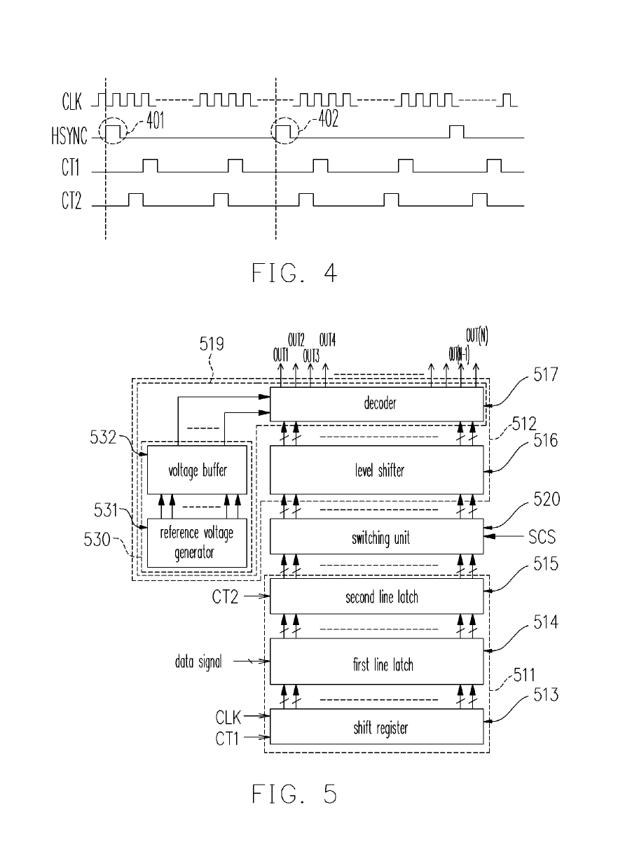

For example, if K=2, the number of the input ends and output ends of the digital circuit portion of the driving apparatus of the present invention (number of channels) is a half of the number of channels of the conventional column driver channels. Therefore, the frequencies of signals CT1 and CT2 received by the driving apparatus must be doubled. FIG. 3 and FIG. 4 are respectively used to illustrate the present invention.

FIG. 3 is a signal timing diagram of the conventional column driver as shown in FIG. 1. FIG. 4 is a signal timing diagram of the driving apparatus of FIG. 2 according to an embodiment of the present invention. In FIG. 3 and FIG. 4, CLK indicates the clock signal, HSYNC indicates a horizontal synchronous signal, CT1 indicates the first control signal, and CT2 indicates the second control signal. It can be seen from FIG. 3 that between two pulse waves of the horizontal synchronous signal (indicated by 301 and 302 in FIG. 3), the first control signal CT1 and the second control signal CT2 have one pulse wave respectively. However, it can be seen from FIG. 4 that between the two pulse waves of the horizontal synchronous signal (indicated by 401 and 402 in FIG. 4), the first control signal CT1 and the second control signal CT2 have two pulse waves respectively.

Those of ordinary skill in the art can dispose the switching unit 220 of FIG. 2 at another position of the digital circuit portion without departing from the spirit of the present invention and the teaching of the above embodiments, for example, between the second line latch 215 and the level shifter 216 as shown in FIG. 5. FIG. 5 shows a driving apparatus according to another embodiment of the present invention. Referring to FIG. 5, the signal converting unit 512 includes a signal converter 519 and a level shifter 516. Here, the signal converter 519 includes a decoder 517 and a reference voltage generating unit 530. The data latch unit 511 includes a shift register 513, a first line latch 514, and a second line latch 515. The shift register 513, the first line latch 514, the second line latch 515, and the reference voltage generating unit 530 in FIG. 5 are respectively identical with the shift register 213, the first line latch 214, the second line latch 215, and the reference voltage generating unit 230 in FIG. 2, and thus the coupling relationship and function thereof will not be described herein again.

The switching unit 520 receives a switch-control signal SCS and switches each of the input ends to one of the corresponding output ends selected according to the switch-control signal SCS, and selects N/K output ends from N output ends for outputting data. The switching unit 520 can be implemented with the DEMUX in this embodiment. Each of the input ends of the signal converting unit 512 is respectively coupled to a corresponding output end of the switching unit 520. The signal converting unit 512 receives the data signals output by the switching unit 520, converts the data signals into N driving signals OUT1˜OUT(N), and then outputs N driving signals OUT1˜OUT(N) to the N data lines of the display panel (not shown).

In the signal converting unit 512, N input ends of the level shifter 516 are respectively coupled to the corresponding output ends of the switching unit 520 for receiving the data signals output by the switching unit 520 and changing the voltage levels thereof, and outputting the data signals with the voltage level changed respectively from the N output ends of the level shifter 516. In the signal converter 519, N input ends of the decoder 517 are respectively coupled to the corresponding output ends of the level shifter 516 for receiving the N data signals output by the level shifter 516. The N channels of the decoder 517 respectively select the reference voltage signals provided by the reference voltage generating unit 530 as driving signals according to the corresponding data signals output by the level shifter 516, and output the driving signals.

It is obvious to those of ordinary skill in the art that the signal converter 519 can be implemented in another manner. For example, the reference voltage generator 531 is directly connected to the decoder 517, and the voltage buffer 532 is disposed between the decoder 517 and the display panel (not shown) instead. Or, a digital-to-analog converter having at least N channels is used to implement the signal converter 519. If those of ordinary skill in the art use the digital-to-analog converter to implement the signal converter 519, each of the channels of the digital-to-analog converter is respectively coupled to a corresponding output end of the level shifter 516. The digital-to-analog converter receives the data signals output by the level shifter 516, converts the data signals into N driving signals OUT1˜OUT(N), and outputs the N driving signals OUT1˜OUT(N) to the display panel (not shown).

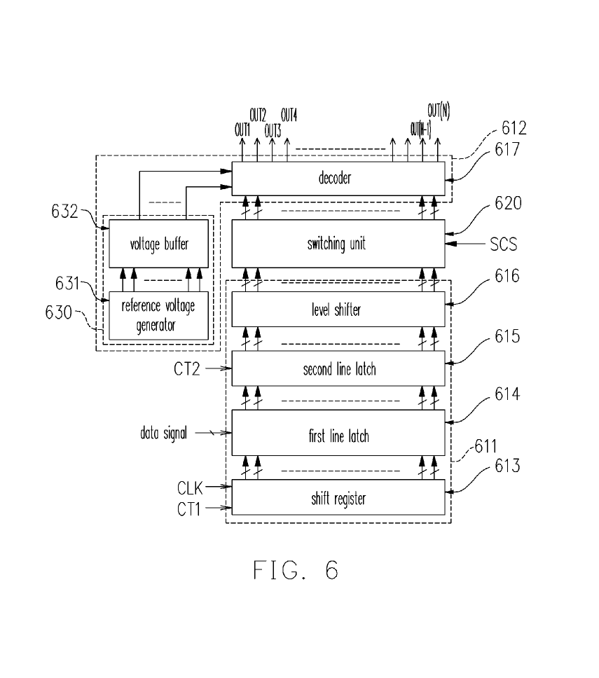

Similarly, the switching unit 220 as shown in FIG. 2 can also be disposed between the level shifter 216 and the decoder 217, as shown in FIG. 6. FIG. 6 is a driving apparatus according to another embodiment of the present invention. Referring to FIG. 6, the data latch unit 611 in FIG. 6 includes a shift register 613, a first line latch 614, a second line latch 615, and a level shifter 616. The signal converting unit 612 includes a decoder 617 and a reference voltage generating unit 630. The shift register 613, the first line latch 614, the second line latch 615, the level shifter 616, the switching unit 620, the decoder 617, the reference voltage generating unit 630, the reference voltage generator 631, and the voltage buffer 632 in FIG. 6 are respectively identical with the shift register 213, the first line latch 214, the second line latch 215, the level shifter 216, the switching unit 220, the decoder 217, the reference voltage generating unit 230, the reference voltage generator 231, and the voltage buffer 232 in FIG. 2, and thus the coupling relationship and the functions thereof will not be described herein again. However, the switching unit 620 is disposed between the level shifter 616 and the decoder 617, so the number of the input ends and output ends of the decoder 617 needs not to be reduced by a factor of K. It is obvious to users that another position for accommodating the switching unit 220 of FIG. 2 can be deduced according to the spirit of the present invention and the teaching of the above embodiments, and the details will not be described herein again.

In view of the above, the number of input ends and output ends of the digital circuit portion of the present invention is reduced to be N/K than that of a conventional column driver (the number of the input ends and output ends thereof is supposed to be N), and the switching unit having N/K input ends and N output ends is adopted to perform K switches for respectively outputting the N/K driving signals which are output by the digital circuit K times, thus achieving the original function of column driver and meanwhile reducing the area and cost of the digital circuit portion. Of course, it is obvious to the user that the above switching unit can also be disposed in the digital circuit portion, and the number of the input ends and output ends of each device in the digital circuit portion must be correspondingly adjusted.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A driving apparatus, suitable for driving a display panel with N data lines, wherein N is a positive integer, the driving apparatus comprising:
a driving unit including N/K output ends, wherein K is a positive integer, the driving unit is used for receiving and latching data signals, and converting the data signals into N/K driving signals and then outputting the N/K driving signals respectively from the N/K output ends; and
a switching unit including N/K input ends and N output ends, for receiving a switch-control signal, selecting N/K output ends from N output ends thereof according to the switch-control signal, and switching each of the input ends thereof respectively to couple to one of the selected output ends thereof, wherein each of the input ends of the switching unit is respectively coupled to a corresponding output end of the driving unit.

2. The driving apparatus as claimed in claim 1, wherein the driving unit comprises:
a data latch unit including N/K output ends, for receiving and latching the data signals, and outputting the latch results respectively from the N/K output ends of the data latch unit after latching the data signals; and
a signal converting unit including N/K input ends and N/K output ends, each of the input ends of the signal converting unit being respectively coupled to a corresponding output end of the data latch unit, the signal converting unit receives the data signals output by the latch unit and converts the data signals into N/K driving signals.

3. The driving apparatus as claimed in claim 2, wherein the data latch unit comprises:
a shift register for receiving a clock signal and a first control signal, generating latch signals according to the clock signal and the first control signal, and then outputting the latch signals respectively from the output ends of the shift register;
a first line latch including input ends and N/K output ends, the input ends of the first line latch being coupled to the output ends of the shift register for receiving the latch signals, latching the data signals according to the timing of the latch signals, and then outputting the latched data signals respectively from the N/K output ends of the first line latch;
a second line latch including N/K input ends and N/K output ends, each of the input ends of the second line latch being respectively coupled to a corresponding output end of the first line latch, the second line latch receives the data signals output by the first line latch, latches the data signals output by the first line latch according to a second control signal, and outputs the latched data signals respectively from the N/K output ends of the second line latch; and
a level shifter including N/K input ends and N/K output ends, each of the input ends of the level shifter being respectively coupled to a corresponding output end of the second line latch, the level shifter receives the data signals output by the second line latch and changes the voltage levels thereof, and then outputs the data signals with the voltage level changed respectively from the N/K output ends of the level shifter.

4. The driving apparatus as claimed in claim 2, wherein the signal converting unit comprises:
a decoder including N/K input ends and N/K output ends, each of the input ends of the decoder being respectively coupled to the corresponding output end of the data latch unit, the decoder receives N/K data signals output by the data latch unit, converts the data signals into the corresponding N/K driving signals, and outputs the N/K driving signals respectively from the N/K output ends of the decoder; and
a reference voltage generating unit coupled to the decoder, for outputting a plurality of reference voltage signals to the decoder, such that the decoder converts the data signals received by the signal converting unit into the corresponding N/K driving signals according to the reference voltage signals.

5. The driving apparatus as claimed in claim 4, wherein the reference voltage generating unit comprises:
a reference voltage generator for generating the reference voltage signals; and
a voltage buffer coupled to the reference voltage generator and the decoder, for receiving and enhancing the driving capability of the reference voltage signals, and outputting the reference voltage signals with the driving capability enhanced to the decoder.

6. The driving apparatus as claimed in claim 2, wherein the signal converting unit comprises a digital-to-analog converter with N/K channels, each of the channels of the digital-to-analog converter being respectively coupled to a corresponding output end of the data latch unit, the digital-to-analog converter receives the data signals output by the data latch unit, converts the data signals into N/K driving signals and then outputs the N/K driving signals.

7. A driving apparatus, suitable for driving a display panel with N data lines, wherein N is a positive integer, the driving apparatus comprising:
a data latch unit including N/K output ends, wherein K is a positive integer, the data latch unit is used for receiving and latching data signals, and outputting the latch results respectively from N/K output ends of the data latch unit after latching the data signals;
a switching unit including N/K input ends and N output ends, for receiving a switch-control signal, selecting N/K output ends from the N output ends according to the switch-control signal, and switching each of the input ends thereof respectively to one of the selected output ends, wherein each of the input ends of the switching unit is respectively coupled to a corresponding output end of the data latch unit; and
a signal converting unit including N input ends and N output ends, each of the input ends of the signal converting unit being respectively coupled to a corresponding output end of the switching unit, the signal converting unit receives the data signals output by the switching unit, converts the data signals into N driving signals and then outputs the N driving signals to the N data lines of the display panel.

8. The driving apparatus as claimed in claim 7, wherein the data latch unit comprises:
a shift register for receiving a clock signal and a first control signal, generating latch signals according to the clock signal and the first control signal, and outputting the latch signals respectively from the output ends of the shift register;
a first line latch including input ends and N/K output ends, the input ends of the first line latch being coupled to the output ends of the shift register for receiving the latch signals, latching the data signals according to the timing of the latch signals, and outputting the latched data signals respectively from the N/K output ends of the first line latch; and
a second line latch including N/K input ends and N/K output ends, each of the input ends of the second line latch being respectively coupled to a corresponding output end of the first line latch, the second line latch receives the data signals output by the first line latch, latches the data signals output by the first line latch according to a second control signal, and outputs the latched data signals respectively from the N/K output ends of the second line latch.

9. The driving apparatus as claimed in claim 7, wherein the signal converting unit comprises:
a level shifter including N input ends and N output ends, each of the input ends of the level shifter being respectively coupled to a corresponding output end of the switching unit, the level shifter receives and changes the voltage levels of the data signals output by the switching unit, and outputs the data signals with the voltage level changed respectively from the N output ends of the level shifter;
a decoder including N input ends and N output ends, each of the input ends of the decoder being respectively coupled to a corresponding output end of the level shifter, the decoder receives the data signals output by the level shifter, converts the data signals into N driving signals, and outputs the N driving signals respectively from the corresponding N output ends of the decoder; and
a reference voltage generating unit coupled to the decoder, for outputting a plurality of reference voltage signals to the decoder, such that the decoder converts the data signals received by the signal converting unit into N driving signals according to the reference voltage signals.

10. The driving apparatus as claimed in claim 9, wherein the reference voltage generating unit comprises:
a reference voltage generator, for generating the reference voltage signals; and
a voltage buffer coupled to the reference voltage generator and the decoder, for receiving and enhancing the driving capability of the reference voltage signals, and outputting the reference voltage signals with the driving capability enhanced to the decoder.

11. The driving apparatus as claimed in claim 7, wherein the signal converting unit comprises:
a level shifter including N input ends and N output ends, each of the input ends of the level shifter being respectively coupled to a corresponding output end of the switching unit, the level shifter receives and changes the voltage levels of the data signals output by the switching unit, and outputs the data signals with the voltage level changed respectively form the N output ends of the level shifter; and
a digital-to-analog converter with N channels, each of the channels of the digital-to-analog converter being respectively coupled to a corresponding output end of the level shifter, the digital-to-analog converter receives the data signals output by the level shifter, converts the data signals into N driving signals, and then outputs the N driving signals.

12. The driving apparatus as claimed in claim 7, wherein the data latch unit comprises:
a shift register for receiving a clock signal and a first control signal, generating latch signals according to the clock signal and the first control signal, and outputting the latch signals respectively from the output ends of the shift register;
a first line latch including input ends and N/K output ends, the input ends of the first line latch being coupled to the output ends of the shift register for receiving the latch signals, latching the data signals according to the timing of the latch signals, and outputting the data signals respectively form the N/K output ends of the first line latch;
a second line latch including N/K input ends and N/K output ends, each of the input ends of the second line latch being respectively coupled to a corresponding output end of the first line latch, the second line latch receives the data signals output by the first line latch, latches the data signals output by the first line latch according to a second control signal, and outputs the latched data signals respectively from the N/K output ends of the second line latch; and
a level shifter including N/K input ends and N/K output ends, each of the input ends of the level shifter being respectively coupled to a corresponding output end of the second line latch, the level shifter receives and changes the voltage levels of the data signals output by the second line latch, and outputs the data signals with the voltage level changed respectively from the N/K output ends of the level shifter.

13. The driving apparatus as claimed in claim 7, wherein the signal converting unit comprises:
a decoder including N input ends and N output ends, each of the input ends of the decoder being respectively coupled to a corresponding output end of the switching unit, the decoder receives the data signals output by the switching unit, converts the data signals into N driving signals, and outputs the N driving signals respectively from the corresponding N output ends of the decoder; and
a reference voltage generating unit coupled to the decoder, for outputting a plurality of reference voltage signals to the decoder, such that the decoder converts the data signals received by the signal converting unit into N driving signals according to the reference voltage signals.

14. The driving apparatus as claimed in claim 13, wherein the reference voltage generating unit comprises:
a reference voltage generator for generating the reference voltage signals; and
a voltage buffer coupled to the reference voltage generator and the decoder for receiving and enhancing the driving capability of the reference voltage signals, and outputting the reference voltage signals with the driving capability enhanced to the decoder.

15. The driving apparatus as claimed in claim 7, wherein the signal converting unit comprises a digital-to-analog converter with N channels, each of the channels of the digital-to-analog converter is respectively coupled to a corresponding output end of the switching unit, the digital-to-analog converter receives the data signals output by the switching unit, converts the data signals into N driving signals, and outputs the N driving signals.
